(19) United States
(12) Patent Application Publication
(10) Pub. No.: US 2014/0252111 A1
(43) Pub. Date: Sep. 11, 2014

(54) AUTO FLUSH-RINSE FOR CHEMICAL INJECTION

(71) Applicant: Raven Industries, Inc., Sioux Falls, SD (US)

(72) Inventors: Nick Michael, Baltic, SD (US); Noel A. Person, Sioux Falls, SD (US); Josh Grabow, Sioux Falls, SD (US); Bryan Engelhart, Sioux Falls, SD (US)

(73) Assignee: Raven Industries, Inc., Sioux Falls, SD (US)

(21) Appl. No.: 13/791,493

(22) Filed: Mar. 8, 2013

(51) Int. Cl. B05B 15/02

(52) U.S. Cl. CPC B05B 15/025
USPC 239/11; 239/112

(57) ABSTRACT

A system comprises a distribution boom having dispensers spaced apart along the distribution boom, a first storage container that contains an agricultural product dispensed using the distribution boom, a pump device that provides a flow stream of the agricultural product to the distribution boom, a second storage container that contains a cleaning agent, a plurality of directional control valves that alter a path of the flow stream including selectively supplying one of the cleaning agent or the agricultural product to the flow stream, and a control module in electrical communication with the pump device, the plurality of directional control valves and a user interface. The plurality of directional control valves are individually controllable by the control module according to an indication received via the user interface.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S.D. All Rights Reserved.

### TECHNICAL FIELD

Embodiments pertain to agricultural applicators. Some embodiments relate to automatic distribution of a cleaning substance within an agricultural chemical applicator system.

### BACKGROUND

Agricultural chemical applicators are used to distribute agricultural products to agricultural crops, a non-exhaustive list of which includes fertilizers, insecticides, herbicides and fungicides. One example of an agricultural product applicator is an agricultural sprayer. Agricultural sprayers typically include one or more distribution booms that are long enough (e.g., 60 feet to 150 feet) to reach multiple rows of crops at one pass. One agricultural sprayer is typically used to distribute multiple types of agricultural products. This requires cleaning of the agricultural sprayer system between applying different products. Additionally, it may be desirable to remove water from the agricultural sprayer to avoid damage to the system plumbing from freezing. Cleaning is typically done by manual operation (i.e., by hand). Typically the user manually opens and closes system valves and flushes one or more ports of the agricultural sprayer with a cleaning solution. This can be cumbersome for large agricultural applicators (e.g., a sprayer that has multiple distribution booms) and as agricultural applicators become more complex.

### OVERVIEW

Systems, devices and methods for improved cleaning of an agricultural product applicator are described herein. A system example includes at least one distribution boom having a plurality of dispensers spaced apart along the distribution boom, a first storage container configured to contain an agricultural product dispensed using the at least one distribution boom, at least one pump device configured to provide a flow stream of the agricultural product to the at least one distribution boom, a second storage container configured to contain a cleaning agent, a plurality of directional control valves configured to alter a path of the flow stream including a directional control valve configured to selectively supply one of the cleaning agent or the agricultural product to the flow stream, a control module in electrical communication with the at least one pump device and the plurality of directional control valves, and a user interface in electrical communication with the control module, wherein the plurality of directional control valves are individually controllable by the control module according to an indication received via the user interface.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an agricultural chemical applicator.

FIG. 2 is a flow diagram of an example of a method for automatic flush and rinse of an agricultural chemical applicator system.

FIG. 3 is a block diagram of portions of an example of a system to provide an automatic flush and rinse of an agricultural applicator system.

FIG. 4 is a block diagram of portions of another example of a system to provide an automatic flush and rinse of an agricultural applicator system.

### DETAILED DESCRIPTION

Agricultural product applicators can include agricultural seeders and agricultural chemical applicators, such as agricultural chemical sprayers and agricultural spreaders for example.

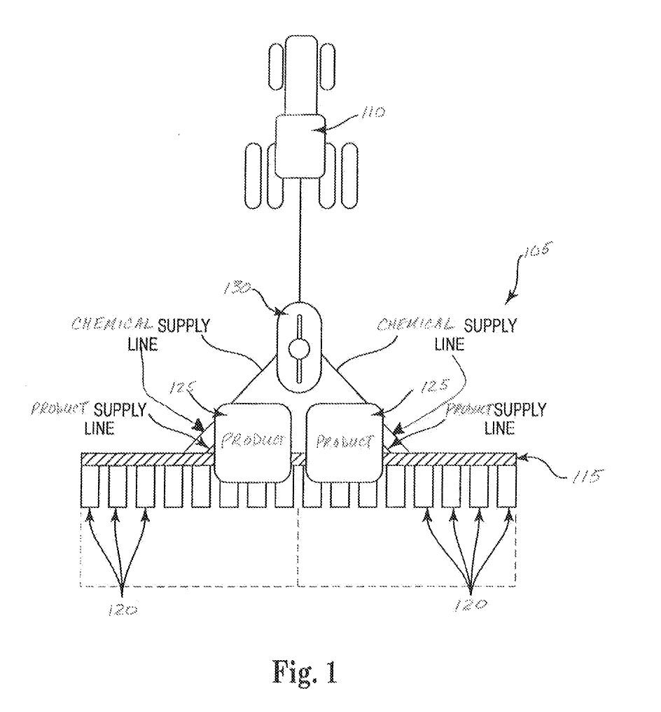

FIG. 1 is an illustration of an example of an agricultural chemical applicator 105. The agricultural chemical applicator 105 is shown mounted to a trailing vehicle behind a lead vehicle 110. The agricultural chemical applicator 105 includes at least one distribution boom 115 or toolbar. The distribution boom 115 includes a plurality of dispensers 120 spaced apart along the distribution boom 115. The agricultural chemical applicator 105 includes one or more storage containers 125 for an agricultural product. The chemical applicator may also include a storage container 130 for an agricultural chemical that is added to the agricultural product. The combined product and chemical may include one or more of a fertilizer, an herbicide, a fungicide and an insecticide. The agricultural product can be supplied to the dispensers 120 by one or more product supply lines and the agricultural chemical can be supplied by one or more chemical supply lines. Valves can be included in the applicator to direct one or more of the agricultural product, the agricultural chemical, and the combination of the product and chemical throughout the system.

As explained previously herein, cleaning or flushing an agricultural product applicator can be cumbersome. System valves are typically operated manually to flush a cleaning solution through the applicator system.

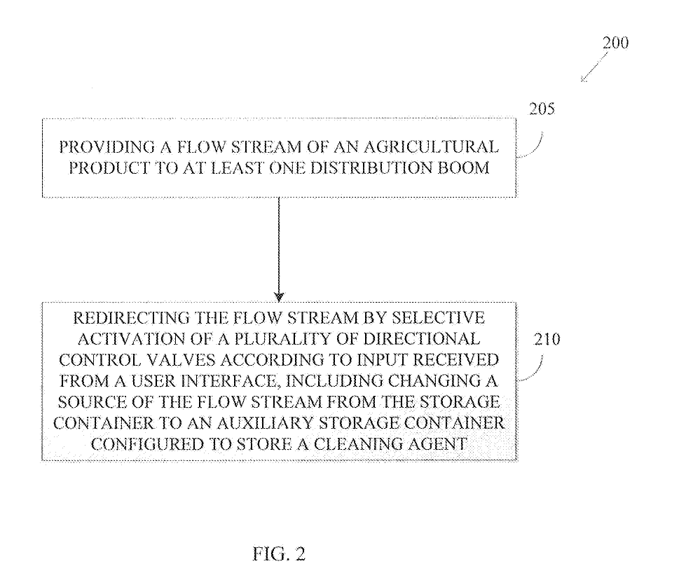

FIG. 2 is a flow diagram of an example of a method 200 for automatic flush and rinse of an agricultural chemical applicator system. At block 205, a flow stream of an agricultural product is provided to at least one distribution boom. The flow stream can be provided from a storage container configured to store the agricultural product. The distribution boom may distribute the agricultural product at spaced locations along the distribution boom. The distribution may be provided by dispensers that are positioned to correspond with rows of agricultural crops planted in a field.

At block 210, the flow stream is redirected by selective activation of a plurality of electrically controllable directional control valves according to input received from a user interface. This automatic redirecting can include changing a source of the flow stream from the storage container to an auxiliary storage container that stores a cleaning agent. The cleaning agent is applied to the agricultural chemical injection system.

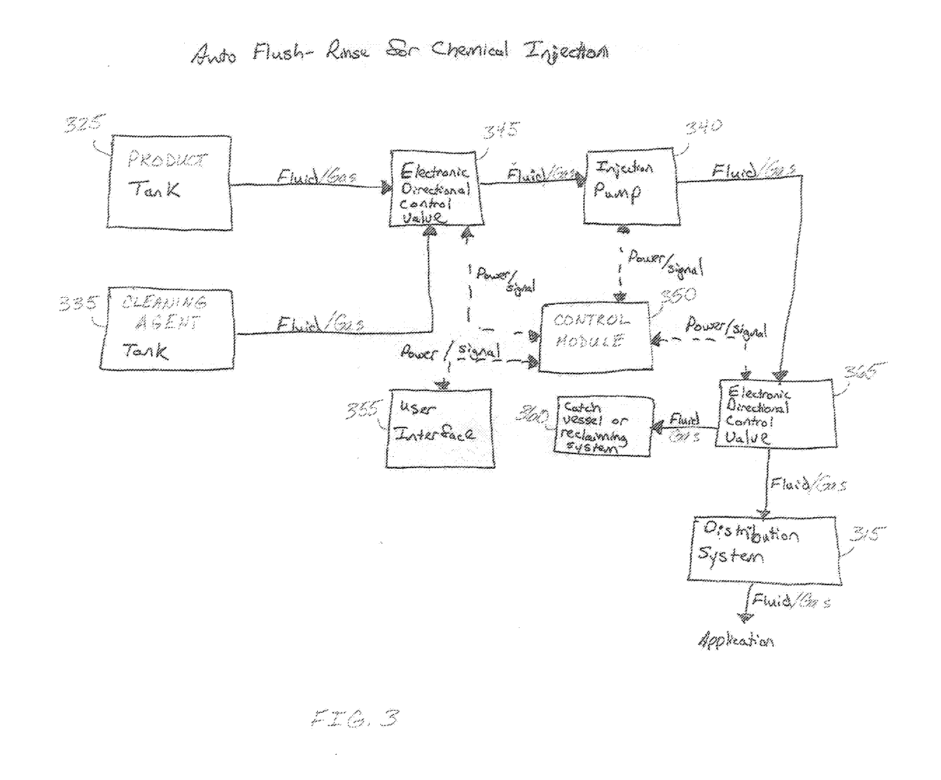

FIG. 3 is a block diagram of portions of an example of a system 300 to provide an automatic flush and rinse of an agricultural applicator system. The system 300 includes a distribution system 315. The distribution system 315 can include at least one distribution boom and multiple dispensers spaced apart along the distribution boom. Some examples of dispensers include release valves and spray nozzles. The system 300 may be mountable to a drive vehicle, or the system 300 may be mountable to a trailing vehicle that is pulled by a leading vehicle.

The system 300 also includes a first storage container 325 that contains an agricultural product dispensed using the at least one distribution boom. At least one pump device 340 is in fluid communication with the at least one distribution boom and the first storage container 325. The pump device 340 provides a flow stream of the agricultural product to the at least one distribution boom. The system 300 includes a second storage container 335 that contains a cleaning agent. In some examples, the cleaning agent can be a liquid, such as water, antifreeze or a chemical neutralizing agent for example. In some examples, the cleaning agent can be a gas such as air, nitrogen gas, or other inert gas for example.

The system 300 includes multiple directional control valves. The directional controls valves can be selectively activated to provide redirection of the flow stream by altering a path of the flow stream. The directional control valves include a first directional control valve 345 that selectively supplies one of the cleaning agent or the agricultural product to the flow stream. The pump device 340 can provide a flow stream of the cleaning agent to the distribution system 315.

To provide automatic and selective activation of the directional control valves, the system 300 includes a control module 350 in electrical communication with the pump device 340 and the directional control valves. The control module 350 can be an electronics unit that includes a processor (e.g., a microprocessor) interpreting or executing instructions in software or firmware to perform the functions described. The control module 350 may include hardware circuits or any combination of hardware, firmware and software. One or both of the control valves and the pump devices can be individually controllable by the control module 350. The control module 350 may individually activate one directional control valve at a time or activate multiple control valves in parallel at the same time. The control module 350 may individually activate one pump device at a time or activate multiple pump devices at the same time.

The system can include a user interface 355 that is in electrical communication with the control module 350. The user interface 355 can include one or more of a display screen, a keyboard, a touchscreen display, and a computer mouse. The directional control valves can be individually controllable by the control module 350 according to an indication received via the user interface 355. The user interface 355 can include a graphical user interface (GUI) that displays a representation of one or more directional control valves. In some examples, the user interface 355 is included in a second device (e.g., a smart phone or tablet computer) executing an application or “app” to send input to the control module 350. The user interface 355 may be in electrical communication with the control module 350 via wireless communication (e.g., radio frequency, ultrahigh frequency (uhf) radio, digital, or infrared wireless communication).

A user may change the configuration of a directional control valve by selecting a control valve using a touchscreen display. The GUI may display a representation of a flow stream and display a representation of a redirected flow stream to a user. For instance, a user may indicate via the user interface 355 to change the source of the flow stream from the product container to the cleaning agent container. The directional control valves are individually controlled or activated by the control module 350 according to the received input to direct the cleaning agent to the distribution boom of the distribution system 315. In certain examples, the cleaning agent may be redirected to one or more output nozzles according to user input received via the user interface 355.

The system 300 may include a cleaning agent recovery system 360, and the cleaning agent may be redirected to the recovery system. This may be useful if the cleaning agent is a cleaning agent solution and recovery of the solution is desired to avoid uncontrolled discharge of the solution (e.g., to allow recovery of the agent solution or to avoid polluting effects by the agent solution). The system 300 can include a second directional control valve 365 that selectively directs the flow stream to the at least one distribution boom of the distribution system 315 or to the cleaning agent recovery system 360. The second directional control valve 365 can be individually controllable by the control module 350 according to an indication received via the user interface 355. The cleaning agent recovery system 360 can include a catch vessel (e.g., a tank) for the cleaning agent solution. The cleaning agent recovery system 360 may include an exhaust nozzle to allow the cleaning solution to be directed to a container (e.g., a beaker, a bucket, or a chemical recovery tank depending on the amount of cleaning solution used). In certain examples, the cleaning agent recovery system 360 can include a flow path back to the second storage container 335 to recover the cleaning agent.

The system 300 may selectively supply a cleaning agent solution or a cleaning agent gas to the flow stream. For instance, the second storage container 335 can store the cleaning agent solution and a third storage container (not shown) can store a gas. The first directional control valve 345 may selectively inject one of the cleaning agent solution, compressed gas, or the agricultural product into the flow stream. The second directional control valve 365 may selectively direct the flow stream to a cleaning agent solution recovery vessel, an exhaust nozzle, or to the at least one distribution boom.

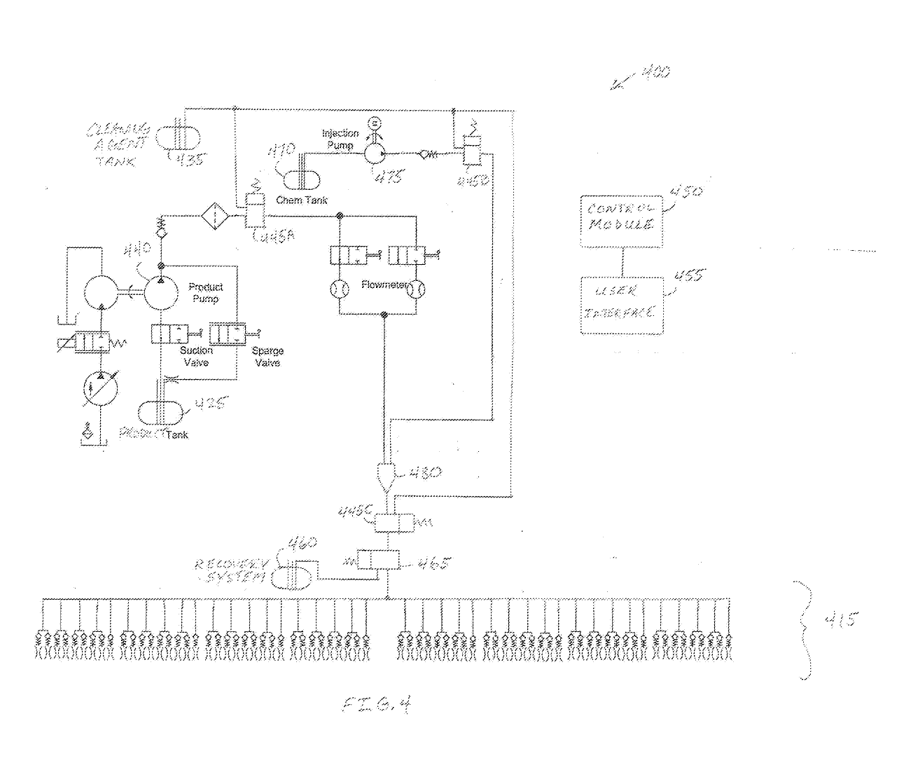

FIG. 4 is a block diagram of portions of another example of a system 400 to provide an automatic flush and rinse of an agricultural applicator system. The system 400 combines an agricultural chemical with the agricultural product to form one or a combination of fertilizer, herbicide, insecticide or fungicide. The system 400 can include a chemical storage container 470 and a second pump device 475 to provide the agricultural chemical to a mixer 480 where the agricultural product and the agricultural chemical are combined. The combined substance is then provided to the distribution system 415. It can be seen from the Figure that the system 400 can include multiple flow streams provided by multiple pumps and multiple directional control valves.

A first directional control valve 445A may selectively direct the cleaning agent or an agricultural product to one or more of the flow streams. The system 400 may include another directional control valve 445B to direct the cleaning agent or the agricultural chemical to one or more of the flow streams. The system 400 may include still another directional control valve 445C to direct the cleaning agent or the combined product and chemical to one or more of the flow streams. The system 400 may include still another directional control valve 465 to selectively direct an output of the one or more flow streams to the at least one distribution boom of the distribution system 415 or to the cleaning agent solution recovery system 460. The system 400 includes a control module 450 and a user interface 455. The control module 450 selectively activates a pump device for one or more of the flow streams and selectively activates multiple directional control valves of the flow streams according to input received via the user interface 455.

It can be seen from the Figures and the detailed description that agricultural systems can become complex as features are added. Complexity of an agricultural system can also increase when the system is expanded. In some examples, the system 400 can include multiple distribution booms in fluid communication with multiple flow streams of the system 400 to distribute an agricultural product or multiple agricultural products. The control module 450 may direct an output of the one or more flow streams to one or more of the distribution booms or to the cleaning agent solution recovery system according to input received via the user interface 455.

The flow streams of complex agricultural application systems may include multiple pump devices of different types. The control module 450 can provide selective control to the different pump device types according to input received from the user interface 455. A non-exhaustive list of such pump device types includes a positive displacement pump device, a peristaltic pump device, centrifugal pump device, a diaphragm pump device and a vane pump device. The flow streams may also include directional control valves of different types. The control module 450 can provide selective control to the different types of directional control valves according to input received from the user interface 455. A non-exhaustive list of different types of directional control valves includes a plunger valve, a ball valve, a globe valve and a spool valve.

It becomes evident from reading this detailed description that cleaning, flushing and rinsing an agricultural product applicator can become quite complex and burdensome for the user. Automation of the cleaning process greatly simplifies the task for the user.

Although the descriptions of systems, devices methods provided herein have been in regard to agricultural chemical applicators, one of skill in the art would understand, upon reading this detailed description, that the descriptions of the several examples are also applicable to agricultural devices such as seeders and planters. The descriptions are also applicable to systems for cleaning center pivot irrigation systems, roadside ditch sprayers, agricultural mowers, and sprayer systems mountable to a boat, airplane and train, as well as hand-operated sprayer devices.

The product applicators have been described in relation to distribution system using distribution booms or toolbars, but the distribution system of the product applicators may include one or more of booms, toolbars, fans, paddles, nozzles or other metering devices to distribute liquid, granular, or gaseous products that may include one or more of water, fertilizers, herbicides, insecticides, fungicides, and seed stock. The automatic flush and rinse systems described herein can be incorporated into a product applicator having any of these types of distribution systems.

### ADDITIONAL NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A system comprising:
at least one distribution boom, wherein the distribution boom includes a plurality of dispensers spaced apart along the distribution boom;
a first storage container configured to contain an agricultural product dispensed using the at least one distribution boom;
at least one pump device in fluid communication with the at least one distribution boom and the first storage container, wherein the at least one pump device is configured to provide a flow stream of the agricultural product to the at least one distribution boom;
a second storage container configured to contain a cleaning agent;
a plurality of directional control valves configured to alter a path of the flow stream, including a first directional control valve configured to selectively supply one of the cleaning agent or the agricultural product to the flow stream;
a control module in electrical communication with the at least one pump device and the plurality of directional control valves; and
a user interface in electrical communication with the control module, wherein the plurality of directional control valves is individually controllable by the control module according to an indication received via the user interface.

2. The system of claim 1, including a cleaning agent recovery system; and a second directional control valve configured to selectively direct the flow stream to the at least one distribution boom or to the cleaning agent solution recovery system, wherein the second directional control valve is individually controllable by the control module according to an indication received via the user interface.

3. The system of claim 2, wherein the cleaning agent includes a cleaning agent solution and the recovery system includes a catch vessel for the solution.

4. The system of claim 1, wherein the cleaning agent includes a gas and wherein the plurality of directional control valves are individually controllable by the control module to direct the gas to the at least one distribution boom.

5. The system of claim 1 including a third storage container configured to store a gas, and wherein the second storage container is configured to store a cleaning agent solution, wherein the first directional control valve is configured to selectively inject one of the cleaning agent, compressed gas, or the agricultural product into the flow stream, and wherein the system includes a second directional control valve configured to selectively direct the flow stream to a cleaning agent solution recovery vessel, an exhaust nozzle, or to the at least one distribution boom.

6. The system of claim 1, including a plurality of flow streams provided by a plurality of pump devices,
wherein the first directional control valve is configured to selectively direct the cleaning agent or an agricultural product to one or more of the plurality of flow streams, and the second directional control valve is configured to selectively direct an output of the one or more flow streams to the at least one distribution boom or to the cleaning agent solution recovery system, and
wherein the control module is configured to selectively activate a pump device for one or more of the plurality of flow streams and selectively activate a plurality of directional control valves of the flow streams according to input received via the user interface.

7. The system of claim 6, including a plurality of distribution booms in fluid communication with the plurality of flow streams, wherein the control module is configured to selectively direct an output of the one or more flow streams to one or more of the plurality of distribution booms or to the cleaning agent solution recovery system according to input received via the user interface.

8. The system of claim 6, wherein the plurality of pump devices are of different types and wherein the plurality of flow streams include electrically controllable directional control valves of different types.

9. The system of claim 8, wherein the different types of pump devices are included in a group consisting essentially of: a piston pump device, a peristaltic pump device, centrifugal pump device, a diaphragm pump device and a vane pump device.

10. The system of claim 8, wherein the different types of electrically controllable directional control valves are included in group consisting essentially of: a plunger valve, a ball valve, a globe valve and a spool valve.

11. The system of claim 1, wherein the user interface includes a graphical user interface (GUI) configured to display a representation of a flow stream, and to display a representation of a redirected flow stream to a user.

12. The system of claim 1, wherein the first storage container is configured to contain, for dispensing by the at least one distribution boom, at least one of liquid fertilizer, liquid herbicide, liquid insecticide or liquid fungicide.

13. The system of claim 1, wherein the system is mountable to a drive vehicle.

14. The system of claim 1, wherein the system is configured to be mountable to a trailing vehicle that is pulled by a leading vehicle.

15. A method comprising:
providing a flow stream of an agricultural product to at least one distribution boom, wherein the flow stream is provided from a storage container configured to store the agricultural product and wherein the distribution boom is configured to distribute the agricultural product at spaced locations along the distribution boom; and
redirecting the flow stream by selective activation of a plurality of directional control valves according to input received from a user interface, wherein the redirecting includes changing a source of the flow stream from the storage container to an auxiliary storage container configured to store a cleaning agent.

16. The method of claim 15, including changing a destination of the flow stream from the distribution boom to a cleaning agent recovery system.

17. The method of claim 15, wherein redirecting the flow stream by selective activation of a plurality of directional control valves includes changing the source of the flow stream from the storage container to at least one of the auxiliary storage container or a compressed gas source and changing the destination of the flow stream from the distribution boom to at least one of the cleaning agent recovery system or an exhaust nozzle according to the input received from the user interface.

18. The method of claim 15,
wherein providing a flow stream of an agricultural product to at least one distribution boom includes providing a plurality of flow streams to the at least one distribution boom by selectively activating a pump device for a flow stream and selectively activating a plurality of directional control valves of the flow streams according to input received via the user interface, and
wherein redirecting the flow stream includes selectively directing the cleaning agent or the agricultural product to the plurality of flow streams and selectively directing an output of the one or more flow streams to the at least one distribution boom.

19. The method of claim 15, wherein providing a flow stream of an agricultural product to at least one distribution boom includes providing a flow stream to a plurality of distribution booms, and wherein the redirecting includes selectively directing an output of the one or more flow streams to one or more of the plurality of distribution booms or to a cleaning agent solution recovery system according to input received via the user interface.

20. An apparatus comprising:
means for providing at least one flow stream of an agricultural product to at least one distribution boom, wherein the flow stream is provided from a storage container configured to store the agricultural product and wherein the distribution boom is configured to distribute the agricultural product at spaced locations along the distribution boom; and
means for redirecting the flow stream by selective activation of a plurality of directional control valves according to input received from a user interface, wherein the redirecting includes changing a source of the flow stream from the storage container to an auxiliary storage container configured to store a cleaning agent.

21. The apparatus of claim 20, wherein the means for redirecting the flow stream by selective activation of a plurality of directional control valves includes means for changing the source of the flow stream from the storage container to at least one of the auxiliary storage container or a compressed air source and means for changing the destination of the flow stream from the distribution boom to at least one of a cleaning agent recovery system or an exhaust nozzle according to the input received from the user interface.
